(19) United States
(12) Patent Application Publication
(10) Pub. No.: US 2010/0028710 A1
(43) Pub. Date: Feb. 4, 2010

(54) OPEN CELL POROUS MATERIAL AND METHOD FOR PRODUCING SAME

(75) Inventors: Emmanuelle Gros, Saint-Pie (CA); Dominic Pilon, Montreal (CA); Alain Harvey, Montreal (CA); Mario Patry, Jonquiere (CA)

Correspondence Address: Osler, Hoskin & Harcourt LLP (Metafoam), 1000 de La Gauchetiere Street West, Suite 2100, Montreal, QC, H3B 4W5, CA

(73) Assignee: METAFOAM TECHNOLOGIES INC., Boucherville, QC (CA)

(21) Appl. No.: 12/297,953

(22) PCT Filed: Apr. 23, 2007
(86) PCT No.: PCT/CA2007/000679

§ 371 Date: May 4, 2009

Related U.S. Application Data
(60) Provisional application No. 60/745,367, filed on Apr. 21, 2006.

(51) Int. Cl. B23K 31/02; B22F 1/00; B32B 5/20

(52) U.S. Cl. 428/613; 228/164; 75/252

(57) ABSTRACT

An open cell porous material and a method for producing it is provided. The porous material of the present invention is generally composed of particles of at least one inorganic material bonded together by a brazing agent, generally provided as inorganic brazing alloy particles. The porous material is produced by heating a mixture comprising inorganic brazing alloy particles having a first melting temperature, inorganic particles having a second melting temperature higher than the first melting temperature, a binding agent having a decomposition temperature lower than the first melting temperature and preferably a foaming agent. In practice, the mixture is heated to induce foaming thereof via the foaming agent. The solid foamed structure is then heated at the decomposition temperature to substantially eliminate the binder. The resulting foamed structure is then heated again at about the first melting temperature to melt the inorganic brazing alloy particles in order to bond together the remaining three-dimensional network of inorganic particles into a rigid structure having interconnected porosity.

### CROSS-REFERENCE TO RELATED APPLICATIONS

The present patent application claims the benefits of priority of commonly assigned U.S. Provisional Patent Application No. 60/745,367, entitled “Open Cell Porous Material and Method for Producing Same” and filed at the United States Patent and Trademark Office on Apr. 21, 2006.

### FIELD OF THE INVENTION

This invention relates to the field of porous materials, and in particular to open cell porous materials and to methods for producing them.

### BACKGROUND OF THE INVENTION

Porous metal or ceramic materials are currently used for the fabrication of devices such as filters, heat exchangers, sound absorbers, electrochemical anodes and cathodes, fuel cells, catalyst supports, fluid treatment units, lightweight structures and biomaterials. The structures (open or closed porosity, pore size, distribution and shape, density) and properties (permeability, thermal, electrochemical and mechanical properties) required greatly depend on the application. Closed porosity is generally sought for lightweight structure while open porosity is particularly seek where surface exchange phenomena are involved or where permeability or pore connectivity is required.

Different approaches have been proposed for the fabrication of such porous materials. Good reviews of manufacturing methods and characterization of porous metal or ceramic material are given in: 1) Michael Ashby, Tony Evans, N. A. Fleck, L. J. Gibson, J. W. Hutchinson, and H. N. G. Wadley, Metal Foams: A Design Guide, Butterworth-Heinemann (Jun. 21, 2000); 2) Handbook of Cellular Metals: Production, Processing, Applications, Hans-Peter Degischer and Brigitte Kriszt Eds., Wiley-VCH (Jun. 10, 2002); 3) Porous and Cellular Materials for Structural Applications, Materials Research Society Symposium Proceedings Vol. 521, Apr. 13-15, 1998, San Francisco, D. S. Schwartz et al. Ed., Materials Research Society; 4) Metal Foams, Fraunhofer USA Metal Foam Symposium, J. Banhart and H. Eifert, ed. Stanton, Del., 7-8 Oct. 1998; and 5) R. Soria, “Overview on Industrial Membranes”, Catalysis Today, 25 (1995), 285-290. Deposition techniques have been used for the fabrication of metal foam. U.S. Pat. No. 4,251,603 and Japanese Laid-Open Patent Application No. 5-6763 describe processes consisting of plating a sponge-like resin and then burning the resin to obtain a metal foam. Deposition may also be done from salts (U.S. Pat. No. 5,296,261) or gas (U.S. Pat. No. 4,957,543). Those processes provide low density materials having open cell porosity.

Direct foaming of melts is described in various patents, for example, U.S. Pat. No. 3,794,481, U.S. Pat. No. 4,713,277, U.S. Pat. No. 4,973,358, U.S. Pat. No. 5,112,696 and PCT Patent Application Nos. WO 91/03578, WO 92/03583, WO 94/172218, WO 91/01387, WO 91/19823, WO 94/09931, WO 92/21457, European Patent No. 0 210803 and Norwegian Patent PCT/NO90/00115. In the techniques described in these patents and patent applications, foaming is carried out by blowing gases into the melt or adding chemical foaming agents such as titanium hydride which release gas when heated and creates bubble in the melt. Melt viscosity is generally adjusted using additives such as silicon carbide, aluminum oxide, magnesium oxide or calcium. These processes provide foams with good mechanical properties. The resulting foams generally have closed porosity.

An alternative approach for producing metal foams from liquid metals is the solid-gas eutectic solidification (Gasars) method such as described in U.S. Pat. No. 5,181,549. The method utilizes an enclosed vessel in which a base material is melted. A gas, whose solubility in the base material decreases with decreasing temperature and increases with increasing pressure, is dissolved into the base material. The metal is then cooled at a predetermined pressure to precipitate the gas and form pores in the solidified material.

Investment casting is also known for the fabrication of metal foams. A polymer foam having open pores is filled with a slurry of heat resistant material. The impregnated foam is then dried and heated at moderate temperature to eliminate the polymer. The resulting heat resistant porous structure is then impregnated with a liquid metal. After solidification, the mold is removed using pressurized water. The final metal foam has the original polymer foam structure. The material has good mechanical properties and large interconnected porosity.

Powder metallurgy has also been extensively used to produce porous materials using different approaches. Some techniques use a combination of solid and liquid state processing to produce metal foam from powders. U.S. Pat. No. 3,087,807 by B. C. Allen, M. C. Mote and A. M. Sabroff describes a method to produce lightweight, porous metal structure comprising the step of compacting a mixture containing aluminum powder and a foaming agent, selected from the group consisting of calcium carbonate, zirconium hydride and titanium hydride, which releases a substantial amount of gas at about the melting temperature of aluminum, extruding the resulting compact below the melting point of aluminum to form a rod, progressively heating the extruded rod to at least the melting temperature of aluminum to produce a foam, and rapidly cooling the resulting foamed material to form a lightweight porous structure having a uniform close cell porosity and density of about 0.45 to 0.58 g/cm³.

A modified approach, described in U.S. Pat. No. 5,151,246 by J. Baumeister and H. Schrader, consists of manufacturing foamable metal bodies in which a metal powder and a foaming agent powder is hot-compacted to a semi-finished product at a temperature at which the joining of the metal powder particles takes place primarily by diffusion and at a pressure which is sufficiently high to hinder the decomposition of the foaming agent in such fashion that the metal particles form a solid bond with one another and constitute a gas-tight seal for the gas particles of the foaming agent. The foamable metal body can also be produced by rolling.

An approach described in U.S. Pat. No. 5,865,237 by F. Schörghuber, F. Simancik and E. Hartl involves providing compacts of a powder of a metal to be foamed and a gas-evolving foaming agent; heating a volume of the compacts in a heatable chamber communicating with a mold having a mold cavity of a shape complementary to the casting to be made which, upon complete foaming, corresponds at least to the volume of the mold cavity, the heating of the compacts being sufficient to at least partially foam the metal of the powder; while the metal of the powder is being foamed in the chamber, forcing the entire contents of the chamber, formed by foaming of the compacts, into the mold cavity; and permitting residual foaming of the contents in the cavity to distribute the foaming metal to all parts of the cavity and produce a foamed metal body conforming completely to the cavity.

Techniques involving the deposition of powders on polymer medium (foams or granules) have also been developed. Those techniques consist in deposing metal or ceramic particles on a polymer and burning the polymer to obtain porous metal or ceramic materials. U.S. Pat. No. 5,640,669 by K. Harada, M. Ishii, K. Watanabe and S. Yamanaka describes a process for preparing a metal porous body having a three-dimensional network structure by deposing a layer comprising copper, a copper alloy, or a precursor thereof on a skeleton composed of a porous resin body having a three dimensional network; heat-treating the resin body with the layer formed thereon to remove the heat-decomposable organic component, thereby forming a porous metal skeleton of copper or a copper alloy.

U.S. Pat. No. 5,759,400 by C. E. Fanning describes the fabrication of metal foams by cutting a polyethylene foam to form a substrate having a desired size and shape, submerging the polyethylene substrate into a solvent for a period of time effective to provide a substrate with a tacky surface, coating the tacky surface of the polyethylene with a slurry of copper powders admixed with a binder, drying the impregnated polyethylene foam, burning the polyethylene in a furnace to produce a foam structure consisting of copper and sintering the final product to obtain a rigid structure. Similar methods using a slurry of copper powders and silver based alloy powders admixed with a binder have also been used.

U.S. Pat. No. 5,881,353 by Y. Kamigata, T. Yoshida, K. Susa; T. Uchida; H. Hiratsuka discloses a method for producing a porous body with high porosity by coating a resin foam, such as urethane foam, with an adhesive to impart stickiness to the surface of the foam, and thereafter a powder such as copper oxide powder is applied thereto, followed by heating to remove the substrate and sinter the powder. Thus, a porous body to which the pattern of the base material has been transferred is produced. The powder may be appropriately selected to obtain porous bodies having a great strength, without limitations on materials.

Methods for preparing porous hollow spheres and sponge like particles are described in U.S. Pat. No. 4,775,598 by M. Jaeckel. Such porous hollow spheres could be used to produce porous materials. The process for making hollow spherical particles, comprising the steps of providing metallized lightweight spherical bodies from cores of a foamed polymer with a metal coating of a thickness of 5 to 20 microns; coating the metallized lightweight spherical bodies with a dispersion of at least one particulate material selected from the group which consists of metals, metal oxides, ceramics and refractories to a dispersion coating thickness of 15 to 500 microns; drying the dispersion coating on the metallized lightweight spherical bodies to form a dry layer of the material thereon; heating the metallized lightweight spherical bodies with the dry layer of the material thereon to a temperature of about 400° C. to decompose the polymer cores and form hollow bodies essentially consisting of the metal coatings and the dry layers of said material thereon; and subjecting the hollow bodies essentially consisting of the metal coatings and the dry layers of the material thereon to a sintering temperature of 900° C. to 1400° C. for a period sufficient to sinter the material of the respective layer and the respective layer to the respective metallic coating, thereby forming hollow spherical particles.

Sintering of freely poured powder, as described in V. M. Kaptsevich et al. “Influence of the Morphology of the Original Powder on the Properties of Porous Materials”, Sov. Powder Metall. Met. Ceram., 29 (4), pp. 308-313 (1990), or in G. Paruthimal et al. “Analysis of Porous Iron Electrodes by Scanning Electron Microscopy”, B. Electrochem., 5 (2), pp. 99-105 (1986), has also been used to produce components having high porosity. Powder mixtures may or may not contain additives such as pore formers or foaming agents. C. Solaiyan et al., “Preparation and Characterization of Porous Electrodes from Nickel Powder for Fuel Cells”, Indian J. of Chemical Technology, 6, pp. 48-54 (1999), describe processes for the preparation of porous electrodes by compacting layers of mixture composed of nickel particles admixed with 5-20 wt % pore formers elements such as Na₂CO₃, KCl, NH₄HCO₃, and naphthalene. C. Stiller et al., “Manufacturing and Characterization of Low Density Titanium Parts”, Proc. of 1998 Powder Metallurgy World Congress & Exhibition, Granada, Spain, Ed. by EPMA, Vol. 5, pp. 189-194, describe a process for manufacturing porous titanium parts by compacting a mixture of titanium powder with a space holder material (carbamide). Materials produced using those techniques have open porosity. Depending on the powder used, fine pore size distribution may be obtained. However, structures with very low density are more difficult to produce.

Slurries have also been extensively used to produce porous materials. The slurries contain metal or ceramic particles, a liquid medium and optionally surface-active agents, binders, gelling agents, stabilizing agents and foaming agents. Optionally, gas may be injected in the slurry. Slurries are cast or poured in a mould. The resulting product is dried at moderate temperature, debinded and sintered to provide strength.

U.S. Pat. No. 5,132,080 by L. B. Pfeil describes an horizontal process for the production of a continuous porous metal strip which comprises forming a slurry of metal powders in a liquid medium, depositing the slurry via leveling means on a flat horizontal moving surface in a slurry layer of uniform thickness, immediately thereafter horizontally passing the slurry layer through an evaporating zone, a calendar zone, and then through a sintering zone whereby the liquid medium is substantially removed and cohesion between the metal particles is subsequently obtained, and thereafter continuously separating the cohesive porous strip thus formed from the moving surface.

U.S. Pat. No. 4,430,294 by V. A. Tracey describes a slurry process for the production of porous nickel bodies characterized by high strength, residual carbon content below about 0.08 wt %, and a porosity exceeding 75 v %, the process consisting essentially of providing a carbonyl nickel powder, forming a nickel-carbon mixture by adding carbon particles to the nickel powder in an amount sufficient to raise the carbon content thereof to about 0.35-2 wt % carbon, the particle size of the carbon no greater than the particle size of the nickel powder, forming a green body from the mixture, sintering the body in a reducing atmosphere, the temperature of the reducing atmosphere being between 750° C. and 1050° C., the reducing atmosphere consisting essentially of hydrogen, nitrogen and 15-30 v % carbonaceous gas, for the time necessary to maintain the porosity of the body above 75 v %. The specimens prepared in the examples were fabricated in aqueous solution of methyl cellulose containing a defoaming agent.

U.S. Pat. No. 3,796,565 by H. A. Hancock and D. J. I. Evans describes a process for making a porous nickel plate including the steps of providing a starting material composed of nickel powder; adjusting the content of nickel oxide in the starting material to about 0.7 to about 1.4 percent by weight; dispersing the so-adjusted starting material in a volatile liquid to form a slurry; heating the slurry to a temperature below sintering temperature but sufficient to evaporate the volatile liquid fraction thereof; and sintering the heated slurry in a reducing atmosphere.

U.S. Pat. No. 4,225,346 by C. D. Helliker and T. D. O'Sullivan describes a process for making porous nickel bodies of various shapes by forming, debinding and sintering a gel mixture, the gel mixture being prepared by mixing together an aqueous solution of modified cellulose ether which gels on heating and a metal powder consisting essentially of nickel and heating this mixture to a temperature between 50 and 120° C. in order to achieve gelling.

U.S. Pat. No. 3,897,221 by I. O. Salyer and R. T. Jefferson discloses a method for preparing porous metal structures by forming a polyurethane structure containing powdered metal, the structure being formed by mixing metal powder in a solution containing the polyurethane forming reactants, polymerizing the mixture in place without stirring after onset of gelation; removing the polyurethane, preferably by heating in air at a temperature below the sintering temperature of the metal, and sintering the remaining porous metal or metal oxide structure.

U.S. Pat. No. 4,569,821 by G. Duperray and M. Hilaire discloses a method for preparing a porous metal body, the method comprising the steps of adding a surface active agent and a gelling agent to water; agitating the mixture to produce a foam; incorporating metal powder into the foam to obtain a suspension of the metal in the foam; adding a stabilizing agent to the foam, stabilizing agent being a material that polymerizes upon contact with water; shaping the stabilized foam suspension; allowing the shaped and stabilized foam suspension to set; and heating the set foam to a temperature high enough to burn the organic material therein and to sinter the suspended metal powder.

U.S. Pat. No. 5,848,351 by K. Hoshino, Y. Mayuzumi, T. Kohno; N. Komada discloses a porous metallic material produced by preparing a foamable slurry containing for example a metal powder, a water-soluble resin binder, a water insoluble hydrocarbon organic solvent (foaming agent), a surfactant and water, forming the foamable slurry, drying the formed product, preferably after foaming, and finally heating the dry formed product to eliminate the resin binder and sinter the material. The obtained material has a low-density three-dimensional network structure, which is composed entirely of a sintered metal powder. The resulting material has high specific surface area.

U.S. Pat. No. 3,833,386 by L. L. Wood, P. Messina and K. C. Frisch discloses a method for the preparation of ceramic foam structures prepared by reacting an isocyanate capped polyoxyethylene polyol reactant with large amount of an aqueous reactant containing finely divided sinterable ceramic material. The resultant foams having the sinterable ceramic material dispersed thereon are heat-treated under firing conditions to decompose the carrier foam and sinter the ceramic particles. The resulting material is a rigid ceramic foam structure.

U.S. Pat. No. 5,213,612 by W. Minnear and B. P. Bewlay discloses a method for forming a porous body of a metal from the group consisting of molybdenum, molybdenum alloys tungsten, tungsten alloys or mixtures thereof comprising the foaming of an aqueous slurry of a sinterable metal powder and a foaming agent in a volume ratio of about 0.6 to 3.5:1 respectively, to form a foam having the metal powder dispersed therein; drying and heating the foam to decompose the foam and sinter the metal powder in a reducing atmosphere to promote interparticle diffusion and bonding.

French patent No. 1,573,864 discloses a method of making a foam or cellular structure. The process described in this patent employs two different types of agent: foaming agents and spacing agents. The effects of these two agents are quite different. Foaming agents create a gaseous volume expansion to create a foam within a liquid. Spacing agents provide bulk, which is subsequently removed to leave voids where the spacing agents were present.

In the first eight examples of the French patent, foaming agents are employed to create a foam from a slurry containing an inorganic powder, a liquid resin and a foaming agent. Example 9 of the French patent discloses a process for making a porous structure wherein a silicium powder is mixed with a liquid binder. The resulting mixture is reduced to powder, mixed with camphor and then compacted into blocks. The camphor is then vaporized to remove it from the blocks and leave voids in its place. In this case the camphor acts purely as a spacing agent since it merely creates bulk, which is removed to create the voids between the particles and no foaming occurs.

U.S. Pat. No. 2,917,384 by M. F. Grandey discloses a method to produce nickel foams using a powder mixture comprising pure nickel powder, silicone resin of the methyl phenyl silane type and optionally a bridged cyanidine compound to increase the rate of foaming. In this method, the silicone resin is referred to as being 100% solids, which generally implies resin without any solvent and generally provided in liquid form. The reference to powder mixture refers to the two powders being mixed into the resin and not to the fact that all the ingredients in the mixture are in powdered form. This is further validated by the fact that there is no reference to the “smelting” of the binder, as would be required if the binder was in powder form. The intimately mixed powders are then placed in a mold and heated at 400° F. to polymerize the resin and to decompose the foaming agent. The foam is then heated in a retort at 1200° F. in a hydrogen atmosphere to remove organic matter and then heated at 2125° F. in the same retort to sinter the metal particles. The resulting open porosity metal foam contains large amount of organic residues as the thermal decomposition of silicon resin done at 800° F. in hydrogen is know to not be complete. Hence, this method does not allow for the production of clean metallic foams. This is the reason why modifications were proposed by the same inventor to overcome this problem in U.S. Pat. No. 3,078,552 which discloses a method to produce clean copper foam using powder mixtures.

U.S. Pat. No. 3,078,552 by M. F. Grandey discloses a method which is an improvement of the process described in U.S. Pat. No. 2,917,384 to minimize the contamination coming from the presence of binder residues after debinding. Additional processing steps have been added to reduce those residues. The method comprises the following steps: producing a mixture of a copper powder, a phenolic foamable resin, a catalyzing agent for phenolic resins, a bodying resin compatible with phenolic resin and a foaming agent; foaming the mixture; heating to preliminarily cure the mixture into a foamed material; heating the material at a temperature and for a time sufficient to decompose the organic ingredients in the mixture; heating the material at a temperature and for a time sufficient to preliminarily sinter the copper powder; heating the material in an oxidizing atmosphere at a temperature lower than that to preliminarily sinter the copper powder and for a time sufficient to oxidize residue of the organic ingredients; and then heating the material at a temperature sufficient to sinter the copper powder. The method, comprising 7 steps, allows for the production of a clean open porosity copper foam. It is important to note that the conditions taught in this method cannot be used with materials sensitive to oxidation, such as titanium, which would not lead to the production of a pure titanium foam. In summary, the process described in U.S. Pat. No. 2,917,384 and U.S. Pat. No. 3,078,552 will generally produce foams that are contaminated with carbon, oxygen or other binder residues, and attempts at subsequent removal of the residues, as described in U.S. Pat. No. 3,078,552, are unsatisfactory for some materials sensitive to oxidation, such as titanium. Furthermore, this method is quite long and costly, since the cost of the process mainly comes from the thermal treatments (4 in all).

U.S. Pat. No. 6,660,224 by L.-P. Lefebvre and Y. Thomas discloses a method of making a clean open porosity porous body, comprising the steps of: a) providing a dry flowable powder mixture comprising 10-90 wt % of sinterable inorganic particles (metal particles for example), 10-90 wt % of solid organic binder particles having clean burn out characteristic, and 0.25-5 wt % of foaming agent; b) shaping the dry flowable powder mixture into a predetermined form; c) heating the resulting product to melt said binder while inducing foaming in the mixture; d) heating the solidified mixture to decompose cleanly said binder; and e) sintering the obtained product to form a solid low density open cell foam. This process produces clean open porosity metallic foams and because there are 2 less thermal treatment steps, they are produced at a lower cost than U.S. Pat. No. 3,078,552.

Powder metallurgy routes have also been developed to produce open cell ceramic foams. A number of reviews on the preparation of ceramic foams are available: 1) J. Saggio-Woyansky, C. E. Scoot, and W. P. Minnear, Am. Ceram. Soc. Bull., 1992, vol. 71, pp. 1674-82; 2) W. P. Minnear, Processing of foamed ceramics. In ceramics Transactions 26: Foaming Science and Technology for Ceramics, ed. M. J. Cima. Am. Ceram. Soc., Westerville, Ohio, 1992, pp. 149-156; 3) P. Sepulveda, Am. Ceram. Soc. Bull., 1997, vol. 76, pp. 61-65; 4) R. W. Rice, Key Eng. Mater., 1996, vol. 115, pp. 1-19; 5) R. W. Rice, Porosity of Ceramics, Marcel Dekker, New York, N.Y., 1998. Generally speaking, the methods consist of mixing fine ceramic powder particles in a polymer based foaming system. The solidified polymer is then removed and the resulting open cell porous ceramic structure is then sintered to solidify it.

Particularly, the use of a aqueous two-part polyurethane system as a vehicle for foaming fine ceramic powder particles as been described in the following: 1) S. J. Powell and J. R. G. Evans, The structure of ceramic foams prepared from polyurethane-ceramic suspensions. Materials and Manufacturing Processes, 1995, vol. 10, pp 757-771; 2) H. X. Peng, Z. Fan, J. R. G. Evans, and J. J. C. Busfield, Microstructure of ceramic foams, J. Europ. Ceram. Soc., 2000, vol. 20, pp. 807-813. The foamed polyurethane is then removed by heating in air and the resulting open cell porous ceramic structure is then sintered to solidify it.

Similar aqueous two-part polyurethane foaming systems have been used for the production of open cell porous titanium, iron and copper structures as described in: C. S. Y. Jee, N. Ozguven, Z. X. Guo, and J. R. G. Evans, Preparation of high porosity metal foams, Met. Mater. Trans. B, 2000, vol. 31B, pp 1345-1352; and 2) S. Xie and J. R. G Evans, High porosity copper foam, J. Mater. Sc., 2004, vol. 39, pp 5877-5880. Following the foaming of the polyurethane system, the polyurethane is removed by heating in air, and the resulting structure is then sintered to produce solid open cell porous metals.

As shown previously, there are, generally speaking, currently two main approaches to manufacture porous material. Using the first approach, the methods comprise at least one step where the main material of the porous material is liquefied. In the second approach, the methods comprise at least one step, generally the last one, where the main material, generally in the form of particles, is sintered. These two approaches are thus either energetically costly and/or provide porous material having unsatisfying mechanical properties. There is therefore a need for a novel method to manufacture open cell porous material which generally obviates the aforementioned shortcomings.

### SUMMARY OF THE INVENTION

The present invention provides a method wherein open cell materials, having a unique microstructure, are obtained by brazing together inorganic particles that are previously foamed from a mixture. Generally, it would be thought that brazing would not be suitable for joining fine particles because when melting, the brazing alloy would not be uniformly distributed and the resulting porous material would not have good mechanical properties.

However, contrary to sintering which is used in the prior art and wherein adjacent particles are only partially bonded, the brazing step of the present invention creates a solid solder-like bond between adjacent particles which results in a porous material having generally improved mechanical properties. Furthermore, the brazing step of the present invention is generally achieved at a lower temperature and in a shorter time than a conventional sintering step, which leads to reduced manufacturing time and reduced energy costs.

For the sake of clarity and to clearly distinguish between the two concepts, as used hereinabove and as will be used hereinafter, the term brazing and the term sintering shall be defined as follows:

Brazing: Brazing is a joining process whereby a generally non-ferrous filler metal or alloy is heated to or above its melting temperature, which is generally referred to its liquidus temperature and is generally above 450° C., and below the melting temperature or solidus temperature of the base material to be joined. The molten filler metal or alloy flows between two or more close-fitting parts of the material to be joined by capillary action. At its melting temperature, the molten filler metal or alloy wets the base material and interacts with a thin layer of the base material, cooling to form an exceptionally strong, sealed joint, in a manner similar to that of a solder and its base metal.

Sintering: Sintering is a method for making objects, generally from powdered material, by heating the material until its particles adhere to each other. Sintering does not melt the material particles to create the bond between them: the material particles adhere to each other through a bond mainly created by solid-state diffusion. Effective solid-state diffusion occurs between material particles when they are heated, for a certain time, at temperatures slightly under the melting temperature of the material particles.

For the sake of clarity and to clearly define the terms used hereinafter, the terms pyrolysis and debinding will be replaced by the term decomposition. Pyrolysis generally refers to the degradation, removal, sublimation, or decomposition of organic materials by heating in the absence of oxygen. Debinding generally refers to the burning-off, removal, or decomposition of organic materials in the presence of oxygen. Hence, hereinafter, both pyrolysis and debinding will be referred to as decomposition of the binder. When needed, the presence or absence of oxygen during the decomposition of the binder will be specifically mentioned.

Accordingly, the present invention provides a generic method for making generally open cell porous body. The method generally comprises the following steps:

a) providing a mixture comprising:
i) a first predetermined amount of inorganic brazing alloy particles having a first melting temperature;
ii) a second predetermined amount of inorganic particles having a second melting temperature, the second melting temperature being higher than the first melting temperature, the inorganic particles being adapted to be brazed by the brazing alloy particles;
iii) a third predetermined amount of a binding agent having a decomposition temperature, the decomposition temperature being lower than the first melting temperature; and
iv) a fourth predetermined amount of a foaming agent;

b) heating the mixture to induce foaming thereof;

c) heating the foamed mixture at the decomposition temperature to decompose the binding agent and to obtain an unbrazed open cell porous body; and

d) heating the unbrazed open cell porous body at about the first melting temperature to melt the inorganic brazing alloy particles, the melted inorganic brazing alloy particles creating metallic bonds between the inorganic particles.

Based on the foregoing generic method, the skilled addressee will readily understand that there exist too many combinations of inorganic particles, inorganic brazing alloys particles, binding agent and foaming agent for the applicant to recite in extensio herein.

In any case, the skilled addressee will be able to determine the predetermined amounts recited above based on the physical and chemical properties of the inorganic particles, of the inorganic brazing alloy particles, of the binding agent and of the foaming agent and based on the desired properties of the finished open cell porous body.

For instance, lighter inorganic particles may require less foaming agent to obtain a certain porosity whereas heavier inorganic particles may require more foaming agent to obtain the same porosity. Also, an open cell porous body made from a first kind of inorganic particles may contain more brazing alloy particles than another open cell porous body made from another kind of inorganic particles in order to have the same mechanical properties.

In the foregoing method, the inorganic particles may be coated particles, metallic particles, metallic alloy particles, ceramic particles, or a mixture of metallic, and/or metallic alloy, and/or ceramic and/or coated particles. The choice of the inorganic particles will depend on the requirements of the application for which the open cell porous material is being manufactured.

The inorganic brazing alloy particles may be any kind of conventional brazing alloy in powdered form like, for example, but in no limiting fashion, silver, copper, lead and/or cadmium based brazing alloys. The choice of the inorganic brazing alloy particles will generally depend on the requirements of the application for which the open cell porous material is being manufactured and on the nature of the inorganic particles to be brazed.

Preferably, the binder may be organic, but it can also be an inorganic and/or synthetic binder, the present invention is not so limited. The choice of the binder will depend on the requirements of the application for which the open cell porous material is being manufactured. Furthermore, the binder can be provided in a solid form, a semi-solid form, a semi-liquid form, a liquid form and/or gel form. Combinations of different binders are also possible and within the scope of the invention.

Preferably, the foaming agent may be a solid, but it can also be a liquid embedded or in solution in the binder, a gas in solution in the binder, or a mixture of two or more of such foaming agents. The choice of the foaming agent will depend on the requirements of the application for which the open cell porous material is being manufactured.

In particular conditions, for example but in no limiting fashion, when a high density and/or low porosity open cell porous material is needed, the foaming agent can be omitted as long as the structure provided before the brazing comprises interconnected pores that allow for the production of an open cell porous material.

Optionally, a cross-linking agent may be added to the mixture to cure the binder and to improve the mechanical strength of the foamed structure before the decomposition of the binder.

Optionally, one or more additional agents may be added to the mixture to minimize segregation and dusting and/or to improve the flowability of the mixture.

Furthermore, spacing agents may be added to provide additional porosity and to improve pore connectivity. The spacing agent can be particles that are added to the initial mixture or a scaffold. The scaffold can be for example, but in no limiting fashion, a polymeric foam. The spacing agents are removed after foaming to leave voids in the structure after the decomposition of the binder and/or the brazing. The spacing agent can be removed by thermal decomposition after foaming or by leaching after foaming, decomposition of the binder or brazing.

The various constituents can be blended together using various techniques including dry mixing, milling or other state of the art mixing techniques. The present invention is not so limited. Whatever the mixing technique used, the resulting product is a homogeneous mixture, which may or may not be agglomerated.

Prior to the molding and foaming steps, the resulting mixture may be shaped using methods such as molding, deposition, extrusion or lamination. The present invention is not so limited.

In accordance with the invention, the mixture is preferably heated in a stepwise fashion during the respective foaming, decomposition of the binder, and brazing processing steps. The mixing and heating processing steps can be done continuously or sequentially or partially continuously and partially sequentially. Optionally, pressure may be applied to the mixture before or during heating of the mixture. The present invention is not so limited. Heating rates and temperature plateaus generally depend on the mixture composition, forming conditions, microstructure and properties required and the applications. Typically, the temperature used to melt the binder and foam the structure ranges from 40° C. to 300° C., but preferably lies between 75° C. and 225° C. Optionally, the heat treatment during the foaming steps may induce some consolidation of the binder by cross-linking if, for instance, thermoset binder or thermoplastic binder with cross-linking agent are used. Still, the heating steps can vary according to the nature of the components of the mixture, namely the binder and/or the foaming agent. The present invention is not so limited.

Materials can be foamed in a mold to provide three-dimensional porous structures. The mixture can be foamed on or in a substrate to produce a coating or to produce composite structures. Foaming can be done for example, but in no limiting fashion, on a plate, on a rod, in or outside a cylinder or tube, in or on other porous structures (mesh, beads, foams for example).

The features of the present invention which are believed to be novel are set forth with particularity in the appended claims.

### BRIEF DESCRIPTION OF THE DRAWINGS

Other aspects and many of the attendant advantages will be more readily appreciated as the same becomes better understood by reference to the following detailed description and considered in connection with the accompanying drawings wherein:

FIG. 1 is a scanning electron microscope picture, at a 500 μm scale, of a porous open cell copper body produced by a sintering process as described in U.S. Pat. No. 6,660,224.

FIG. 2 is a scanning electron microscope picture, at a 200 μm scale, of a porous open cell copper body produced by a sintering process as described in U.S. Pat. No. 6,660,224.

FIG. 3 is a back scattered scanning electron microscope picture, at a 300 μm scale, of a porous open cell copper body produced by a silver based brazing process in accordance with the present invention.

FIG. 4 is a scanning electron microscope picture, at a 100 μm scale, of a porous open cell copper body produced by a sintering process as described in U.S. Pat. No. 6,660,224.

FIG. 5 is a back scattered scanning electron microscope picture, at a 50 μm scale, of a porous open cell copper body produced by a silver based brazing process in accordance with the present invention.

FIG. 6 is a back scattered scanning electron microscope picture, at a 20 μm scale, of a porous open cell copper body produced by a silver based brazing process in accordance with the present invention.

FIG. 7 is a scanning electron microscope picture, at a 50 μm scale, of a porous open cell iron body produced by a sintering process as described in U.S. Pat. No. 6,660,224.

FIG. 8 is a scanning electron microscope picture, at a 20 μm scale, of a porous open cell iron body produced by a sintering process as described in U.S. Pat. No. 6,660,224.

FIG. 9 is a back scattered scanning electron microscope picture, at a 50 μm scale, of a porous open cell iron body produced by a silver based brazing process in accordance with the present invention

FIG. 10 is a back scattered scanning electron microscope picture, at a 50 μm scale, of a porous open cell iron body produced by a silver based brazing process in accordance with the present invention

FIG. 11 is a scanning electron microscope picture, at a 100 μm scale, of a porous open cell nickel body produced by a sintering process as described in U.S. Pat. No. 6,660,224.

FIG. 12 is a back scattered scanning electron microscope picture, at a 10 μm scale, of a porous open cell nickel body produced by a silver based brazing process in accordance with the present invention.

### DETAILED DESCRIPTION OF THE PREFERRED EMBODIMENT

A novel method for producing open cell porous material and the materials produced thereby will be described hereinafter. Although the invention may be described in terms of certain specific illustrative embodiments, it is to be understood that the embodiments described herein are by way of example only and that the scope of the invention is not intended to be limited thereby.

The porous material of the present invention can be produced from a mixture comprising preferably a brazing agent, a base material, a binding agent and a foaming agent, all provided in predetermined amounts. The brazing agent is preferably brazing alloy particles having a first melting temperature, the base material is preferably inorganic particles having a second melting temperature higher than the first melting temperature, the binding agent is preferably, but not exclusively, an organic binder having a decomposition temperature lower than the first melting temperature, and the foaming agent is preferably, but not exclusively, foaming agent particles.

As the person skilled in the art would understand, the exact amount of each constituent of the mixture is determined, prior to the execution of the method of the present invention, based on the physical and chemical properties of the inorganic particles, of the inorganic brazing alloy particles, of the binding agent and of the foaming agent and based on the desired properties of the finished open cell porous body.

Consequently, the exact composition of the mixture will vary according to the nature of the brazing agent, the base material, the binding agent and the foaming agent. Hence, the general composition of the mixture and the general method shall first be described in general terms and then be described according to specific illustrative examples embodying the present invention.

### Generic Composition and Method

According to the present invention, the inorganic particles comprises metallic particles, metallic alloy particles, ceramic particles, coated particles and/or a combination thereof. In the case of metallic and metallic alloy particles, the metal or metals are preferably transition metals (e.g. copper, nickel, iron) as defined by the periodic table of elements. The inorganic particles will have a second melting temperature necessarily higher than the first melting temperature of the inorganic brazing alloy particles in order for the inorganic particles to remain solid while the inorganic brazing alloy particles melt and wet the inorganic particles. Though the inorganic particles content may vary from about 10 to about 90 wt % of the total weight of the mixture (preferably from about 40 to about 90 wt % for metal particles and from about 10 to about 60 wt % for ceramic particles), the exact amount of the inorganic particles and the choice thereof will be determined by the skilled addressee depending on the requirements of the application for which the open cell porous material is being manufactured.

The inorganic brazing alloy particles comprises generally any kind of conventional brazing alloy in powdered form like for example, but in no limiting fashion, silver, copper, and/or cadmium based brazing alloys or a mixture of two or more brazing alloys in powdered form. The inorganic brazing alloy particles will have a first melting temperature and, though its content may vary from about 1 to about 60 wt % of the total weight of the mixture and preferably vary from about 5 to about 45 wt % of the total weight of the mixture, the exact amount of inorganic brazing alloy particles and the choice thereof will be determined by the skilled addressee depending on the nature of the inorganic particles and on the requirements of the application for which the open cell porous material is being manufactured.

According to the method of the present invention, the binder used in the mixture is generally and preferably an organic binder. The binder can be a thermoplastic polymer, a thermoset resin and/or a combination thereof. The present invention is not so limited. The binder can also be an inorganic, a synthetic binder or a mixture of organic and/or inorganic and/or synthetic binders. The binder may be provided in solid form (preferably powder particles), in semi-solid for, in liquid form, in gel form or in semi-liquid form. The binder will have a decomposition temperature lower than the first melting temperature of the inorganic brazing alloy particles in order to prevent premature melting of the brazing alloy particles during the decomposition step. Though the binder content in the mixture may vary from about 10 to about 90 wt % of the total weight of the mixture and preferably from about 20 to about 70 wt %, the exact amount thereof will be determined by the skilled addressee depending on the nature of the inorganic particles and the brazing alloy particles and on the requirements of the application for which the open cell porous material is being manufactured. The skilled addressee will understand that the binder should have an adequate viscosity during foaming to promote material expansion during the manufacturing process.

Optionally and/or if necessary, the mixture may comprise a cross-linking agent that may induce curing of the binder during or after the foaming step and, by the way, improve the mechanical strength of the foamed structure before the decomposition of the binder. Optionally, the mixture may also comprise other additives such as a lubricant to ease shaping, molding or demolding or flowing agents to improve the flowability of the powder when all the constituents are in powdered form. The present invention is not so limited.

The organic binder can be blended with the other constituents using various techniques such as but not limited to mixing, milling, mixing the binder in suspension or in solution in a liquid, blending the binder in molten, liquid, gel or semi-liquid form with the inorganic brazing allow particles, inorganic particles and the other additives. Whichever mixing technique is used, the resulting product should be a foamable mixture.

In the preferred embodiment of the present invention, the mixture preferably comprises a foaming agent in an amount ranging from about 0.01 to about 5 wt % based on the total weight of the mixture and most preferably in an amount ranging from 0.05 to about 2 wt %. Still, the exact amount of foaming agent will be determined by the skilled addressee depending on the nature of the inorganic particles and the brazing alloy particles and on the requirements of the application for which the open cell porous material is being manufactured. In any case, the choice of the foaming agent is made such that gaseous species will be released in the temperature range where the binder is in liquid form. Ideally, the foaming agent should not leave decomposition products that may negatively affect the final properties of the foamed structure. However, some residues can be accepted if they have no impact on the final product or if they improve some of its properties.

In variant of the preferred embodiment, when a high density and/or low porosity and/or high mechanical strength open cell porous material is needed, the foaming agent can be omitted if the structure provided before brazing nevertheless comprises interconnected pores that allow for the production of an open cell porous material according to the present invention.

Typically, the foaming agent is mixed in powder form with the other constituents of the mixture using state of the art techniques. The foaming agent may also be added in suspension or in solution. The liquid is then removed by evaporation optionally with heat, under vacuum or through a combination thereof. The foaming agent may also be mixed in the melted state with the other constituents of the mixture. The foaming agent may also be incorporated in the binder in the solid, liquid or gaseous state. As for the binding agent, whichever mixing technique and foaming agent are used, the resulting product should be a foamable mixture.

In other variants of the preferred embodiment, spacing agents may be added to the mixture for providing additional porosity and to improve pore connectivity. The spacing agents are removed after foaming to leave voids in the structure after decomposition of the binder or after brazing. The spacing agent can be removed by thermal decomposition after foaming or by leaching after foaming, decomposition of the binder or brazing. The spacing agent can be particles or a scaffold. When particles are used, they are admixed with the rest of the mixture. In one non limitative example, the spacing agent can be polymeric particles admixed with the mixture. In this case, the spacing agent concentration can vary from about 5 to 50 wt %, but preferably between 10 and 30 wt %. When a scaffold is used, its porous structure is filled with the mixture used to produce the foam. The scaffold can be, for example and in no limiting fashion, a porous structure, like a polymeric foam, that can be filled with the mixture and removed by thermal decomposition or by leaching.

It is also contemplated to add additional binder in amount varying between 0.05 wt % to 5 wt %, but preferably between 0.05 wt % to 1 wt %, in the mixture. This additional binder is generally used to glue different constituents of the mixture together in such a way that the final product is less prone to segregation and/or dusting. This additional binder can also be used to improve the flowability of the mixture should all the constituents be provided in powdered form. The additional binder may be added at different steps of the mixing procedure, either before mixing the inorganic brazing alloy particles and/or the inorganic particles with the other constituents, after the binder addition, after the foaming agent addition, after the lubricant addition, after the flowing agent addition or after the addition of any combination of those constituents. Whichever mixing technique is used, the resulting product should be a foamable mixture.

The resulting mixture may be shaped using methods such as molding, deposition, lamination or extrusion. The product is then heated at a moderate temperature to melt the binder, if the latter is not already in liquid, gel or semi-liquid form, and to initiate the foaming of the mixture. Optionally, pressure may be applied to the mixture before or during heating the mixture.

The resulting open cell porous material porosity and structure will depend on the particle size, shape, density and content of the inorganic brazing alloy particles; on the particle size, shape, density and content of the inorganic particles; the content and viscosity of the binder; the content, distribution and vaporization or decomposition characteristics of the foaming agent, as well as the processing conditions.

Materials can be foamed in a mold to provide three-dimensional porous structures. The mixture can be foamed on or in a substrate to produce a coating or to produce composite structures. Foaming can be done for example on a plate, on a rod, in or outside a tube or cylinder, in or on other porous structure (mesh, beads, foam for example) or any other substrate. The material can be machined after foaming, decomposition of the binder or brazing.

Functionally graded materials can be produced using mixtures with variable composition. Graded layered structures can be produced for example by deposing layers of mixtures with different composition. Functionally graded materials can also be produced by controlling the thermal gradient during foaming in order to control material foaming and pore size distribution.

Optionally, the mechanical strength of the foamed structure may be further increased, before decomposition of the binder and brazing, by using externally assisted cross-linking techniques such as irradiation or light exposure.

After foaming and optionally cross-linking, the foamed mixture is treated at higher temperature to decompose the binder. The atmosphere (with or without the presence of oxygen), duration and temperature of the thermal treatment should preferably allow a clean decomposition of the binder. Binder decomposition should preferably not deteriorate the three-dimensional structure of the foamed mixture. If gas pressure generated during binder decomposition is too important, cracking may occur in the still unbrazed structure. Oxidizing or reducing conditions during the thermal treatments may be chosen to optimize binder decomposition. After decomposition, the foamed mixture is composed of open cell metal, and/or metal alloy, and/or ceramic material with brazing alloy particles.

Brazing is done after the decomposition of the binder to create bonds between the inorganic particles of the foamed mixture. Brazing conditions (temperature, time and atmosphere) must be such that the inorganic brazing particles will melt, flow between the inorganic particles through capillary force, wet the inorganic particles, interacts with a thin layer of the inorganic particles, and cool to form a strong joint between the inorganic particles. Generally, but not exclusively, the brazing temperature is at or above the melting temperature of the inorganic brazing alloy particles, commonly referred to as the liquidus temperature. Brazing is generally done in reducing atmosphere for metal particles to avoid the formation of surface oxides on the foam.

The final product generally, but not exclusively, has a low-density open-cell structure. Density varies, typically between 50 and 95% of the theoretical density of the material, but preferably between 60 and 90%. The resulting product generally has three different levels of pore sizes. Large pores may be attributed to the formation of the cells and their coalescence during foaming, intermediate pores to the windows formed in the cell wall during foaming and to the decomposition of the binder during the decomposition step, and fine micro-pores to the void between the particles. Depending on the amount of brazing alloy particles in the mixture and on the temperature and duration of the brazing step, the fine micro-pores may be more or less eliminated during brazing.

Mechanical strength may be adjusted for the application. The choice, size, nature and/or physical state of the inorganic brazing alloy, of the inorganic particles, of the binder and of the foaming agent content will have a substantial influence of the physical properties (e.g. mechanical strength) of the produced open cell porous material.

Additional treatment can be done on the foam produced. The internal surface of the foam can be modified for example by heat treatment, chemical treatment or deposition of coatings using various state of the art deposition techniques. The external surfaces of the foam can be modified for example by a stamping, etching or grooving technique and by state of the art surface coating techniques. The foams can be integrated in other products and/or to other structures using different state of the art techniques such as diffusion bonding, press fitting, welding, brazing, sintering or gluing. The invention is not so limited.

Three embodiments of the present invention shall be described in the non limitative following example.

### Example 1

Open cell porous metal samples, with copper (Cu) as the based material, were produced with the formulation presented in Table 1 and in accordance with the present invention. The different constituents were dry-mixed together until the mixture became homogeneous. After mixing, the mixture was poured into a mould and foamed at 110° C. in air for 2 hours. After foaming, the material was submitted to the decomposition of the binder in a tube furnace at 650° C. for 4 hours in a dry air stream. Finally, the specimens were brazed in an Ar-25% H₂ atmosphere for 1 hour at 780° C.

TABLE 1
Formulation used for the production of the Cu based foam

| Inorganic brazing | Inorganic | Binding | Foaming |
|---|---|---|---|
| alloy particles | particles | agent | agent |
| Silver based alloy | Cu powder | Phenolic | P-toluene sulfonyl |
| (72 wt. % Ag & 28 | | resin | hydrazide |
| wt. % Cu) | | | |
| 11.7 wt. % | 58.3 wt. % | 29.5 wt. % | 0.5 wt. % |

Open cell porous copper (Cu) samples were produced with the formulation presented in Table 2 and in accordance with the procedure described in U.S. Pat. No. 6,660,224. The different constituents were dry-mixed together until the mixture became homogeneous. After mixing, the mixture was poured into a mould and foamed at 110° C. in air for 2 hours. After foaming, the material was submitted to the decomposition of the binder in a tube furnace at 650° C. for 4 hours in a dry air stream. Finally, the specimens were sintered in an Ar-25% H₂ atmosphere for 3 hours at 950° C. Notice the higher temperature and longer time of heating compared to the one used in the method of the present invention.

TABLE 2
Formulation used for the production of the Cu foam

| Inorganic | Binding | Foaming |
|---|---|---|
| particles | agent | agent |
| Cu powder | Phenolic | P-toluene sulfonyl |
| | resin | hydrazide |
| 70 wt. % | 29.5 wt. % | 0.5 wt. % |

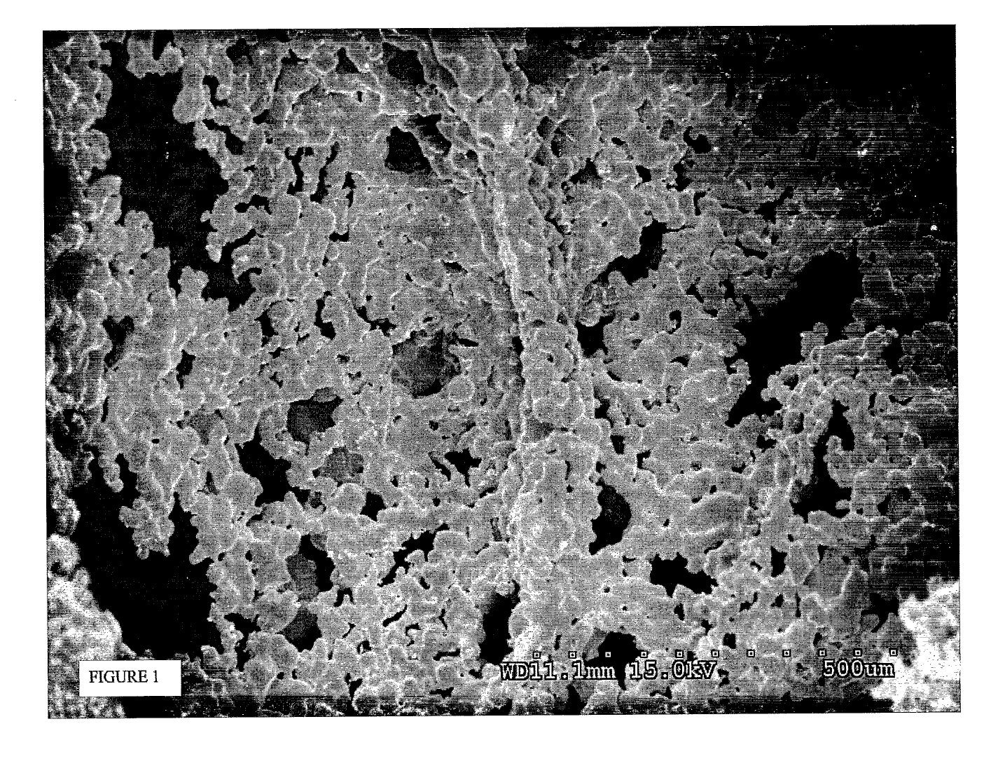

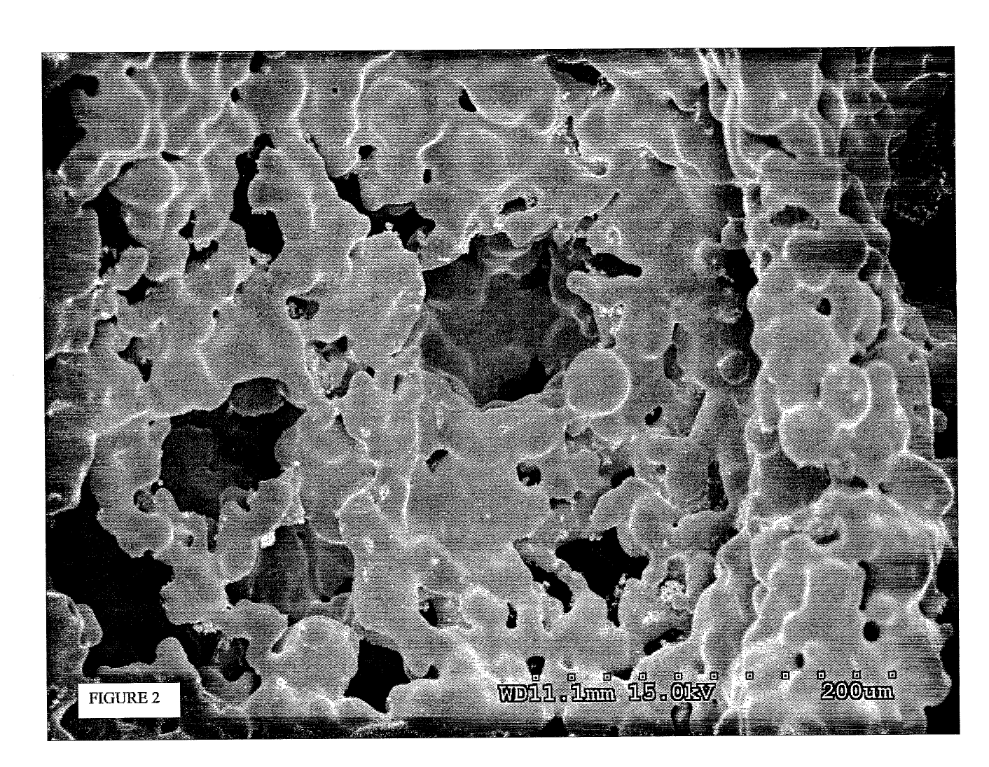

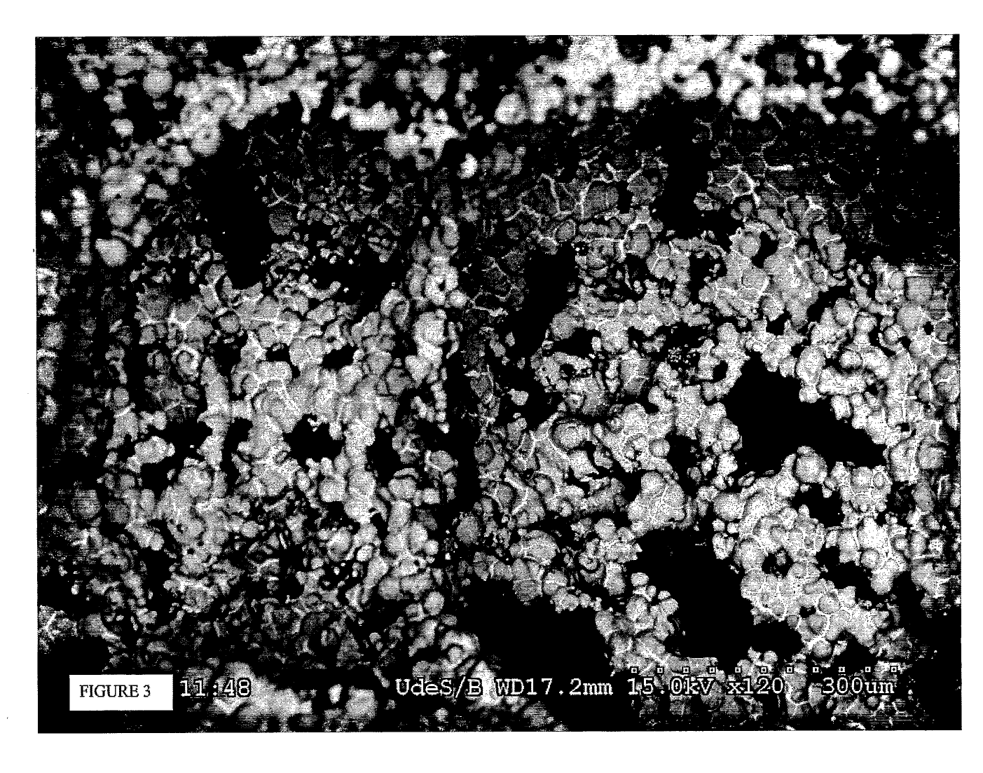

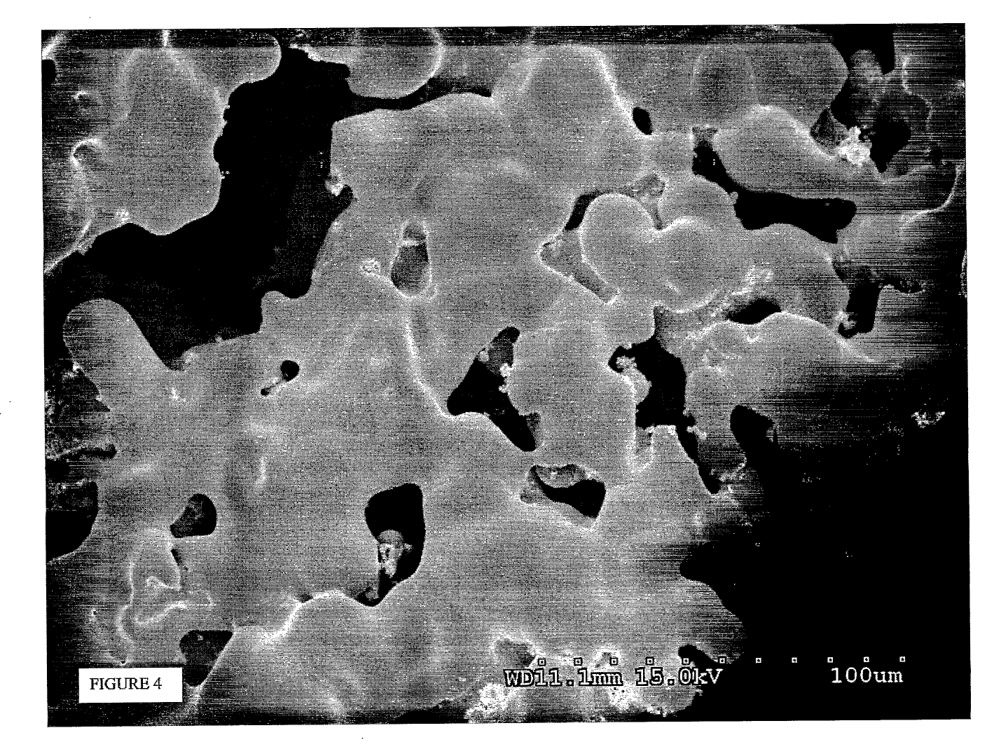

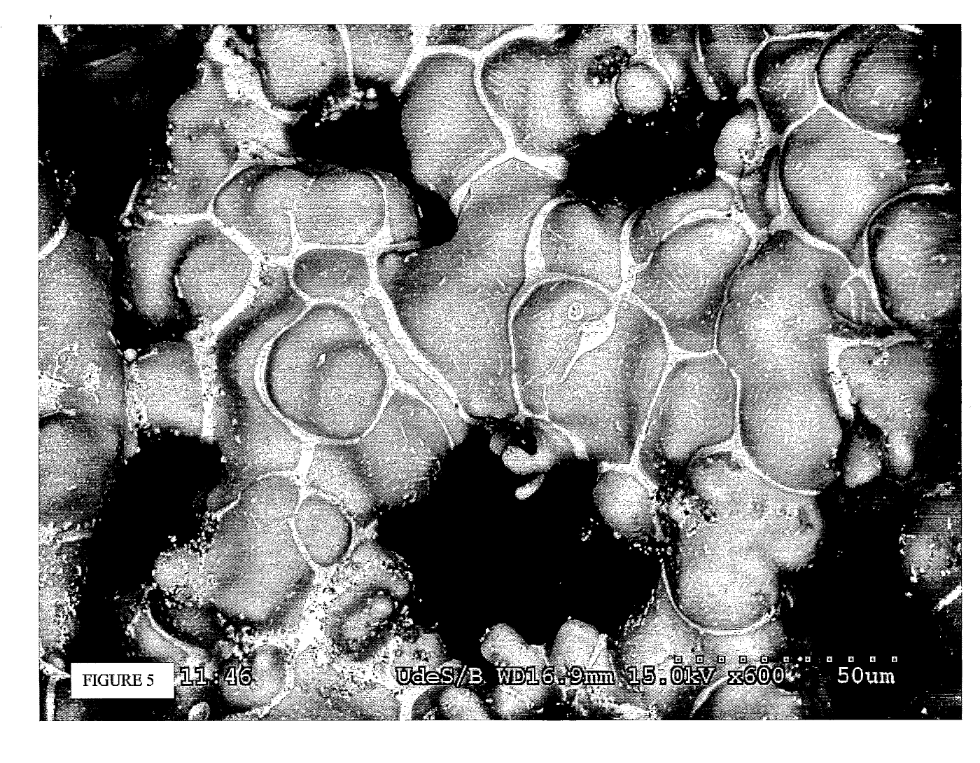

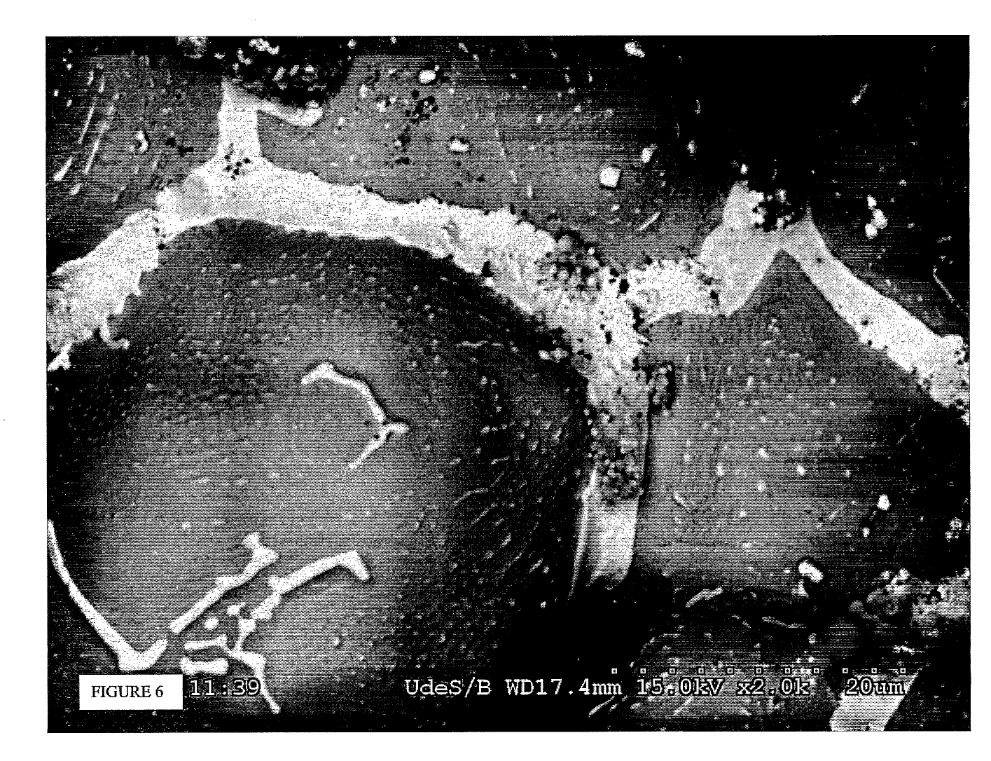

FIGS. 1, 2, and 4 show scanning electron microscope pictures of the open cell porous Cu samples produced in accordance with the procedure described in U.S. Pat. No. 6,660,224 and detailed in Table 2. On the other hand, FIGS. 3, 5, and 6 show back scattered scanning electron microscope pictures of the open cell porous Cu based samples produced in accordance with the present invention and detailed in Table 1. In FIGS. 3, 5, and 6, the molten inorganic brazing alloy (mainly silver) is the one represented by the lighter shade of gray and the inorganic base material, namely the copper, is represented by the darker shade of gray. It can be clearly seen that the molten inorganic brazing alloy generally concentrate itself in the bonding area or region between two adjacent particles of the inorganic base material, creating a strong, sealed joint between the inorganic particles. The remaining surface remains substantially free of the inorganic brazing alloy. In comparison, it can be clearly seen that microstructure presented in FIGS. 1, 2, and 4 are clearly different, as no sealed joints created by an inorganic brazing alloy are present between the copper particles.

To demonstrate the enhanced mechanical properties of the Cu based foam produced according to the present invention, compression tests were done using a 100 kN MTS hydraulic machine on two open cell porous samples: 1) a first sample of open cell porous Cu based material produced in accordance with the present invention and detailed in Table 1; 2) a second sample of the open cell porous Cu material produced in accordance with the procedure described in U.S. Pat. No. 6,660,224 and detailed in Table 2. The sample produced according to the present invention had a Young's modulus and a yield stress around 345 MPa and 2.05 MPa respectively. As for the sample produced according to the method described in U.S. Pat. No. 6,660,224, its Young's modulus and yield stress were around 105 MPa and 0.25 MPa respectively. This demonstrates that by using the brazing method of the present invention for making open cell porous material, it is possible to produce open cell porous material having better mechanical properties than open cell porous material produced by prior art processes using a sintering step, and this, while reducing heating time and temperature during the final heating step.

### Example 2

Open cell porous metal samples, with iron (Fe) as the based material, were produced with the formulation presented in Table 3 and in accordance with the present invention. The different constituents were dry-mixed together until the mixture became homogeneous. After mixing, the mixture was poured into a mould and foamed at 110° C. in air for 2 hours. After foaming, the material was submitted to the decomposition of the binder in a tube furnace at 400° C. for 4 hours in a dry air stream. Finally, the specimens were brazed in an Ar-25% H₂ atmosphere for 30 minutes at 895° C.

TABLE 3
Formulation used for the production of the Fe based foam

| Inorganic brazing | Inorganic | Binding | Foaming |
|---|---|---|---|
| alloy particles | particles | agent | agent |
| Silver based alloy | Fe powder | Phenolic | P-toluene sulfonyl |
| (56 wt. % Ag & 42 | | resin | hydrazide |
| wt. % Cu & 2 wt. % Ni) | | | |
| 15 wt. % | 55 wt. % | 29.5 wt. % | 0.5 wt. % |

Open cell porous iron (Fe) samples were produced with the formulation presented in Table 4 and in accordance with the procedure described in U.S. Pat. No. 6,660,224. The different constituents were dry-mixed together until the mixture became homogeneous. After mixing, the mixture was poured into a mould and foamed at 110° C. in air for 2 hours. After foaming, the material was submitted to the decomposition of the binder in a tube furnace at 400° C. for 4 hours in a dry air stream. Finally, the specimens were sintered in an Ar-25% H₂ atmosphere for 30 minutes at 895° C.

TABLE 4
Formulation used for the production of the Fe foam

| Inorganic | Binding | Foaming |
|---|---|---|
| particles | agent | agent |
| Fe powder | Phenolic | P-toluene sulfonyl |
| | resin | hydrazide |
| 70 wt. % | 29.5 wt. % | 0.5 wt. % |

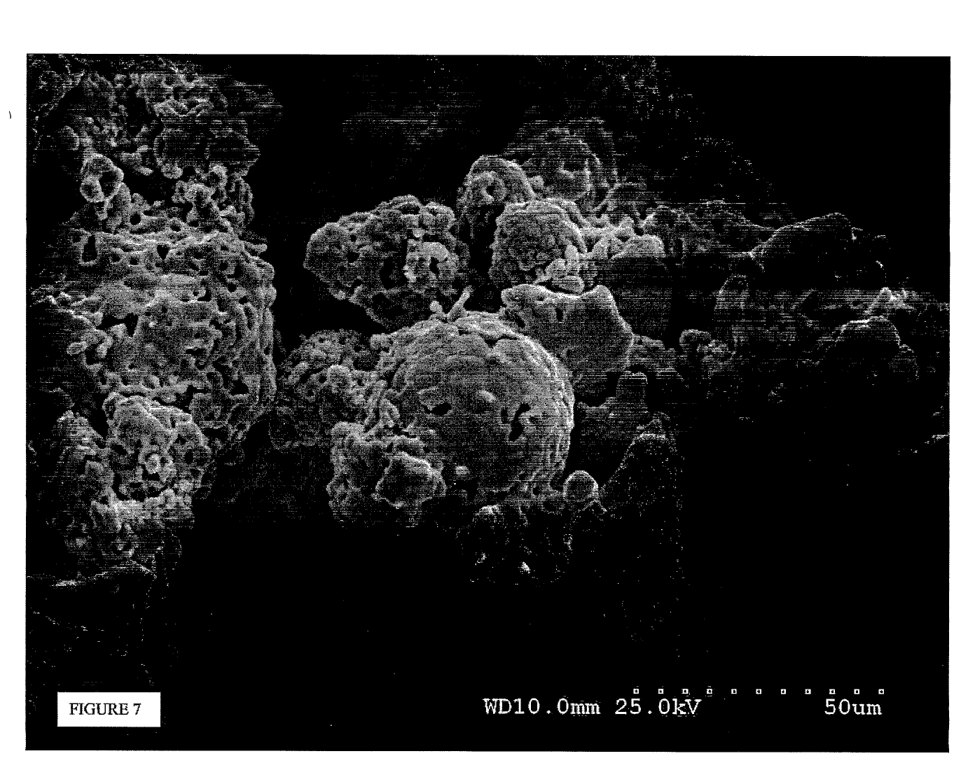

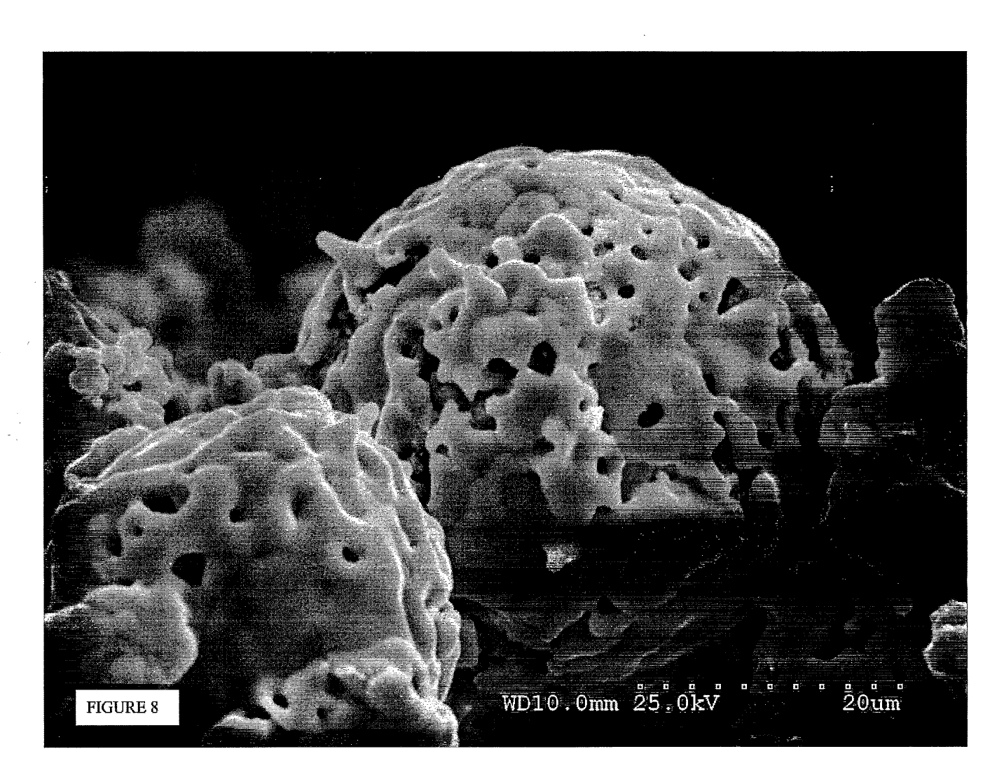

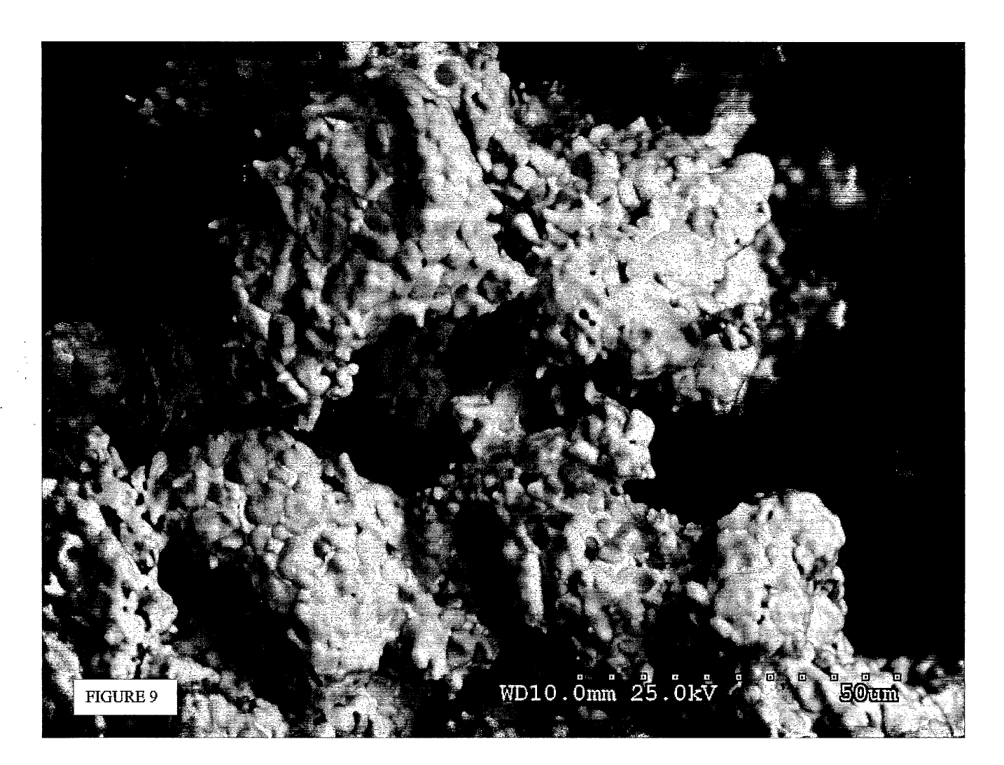

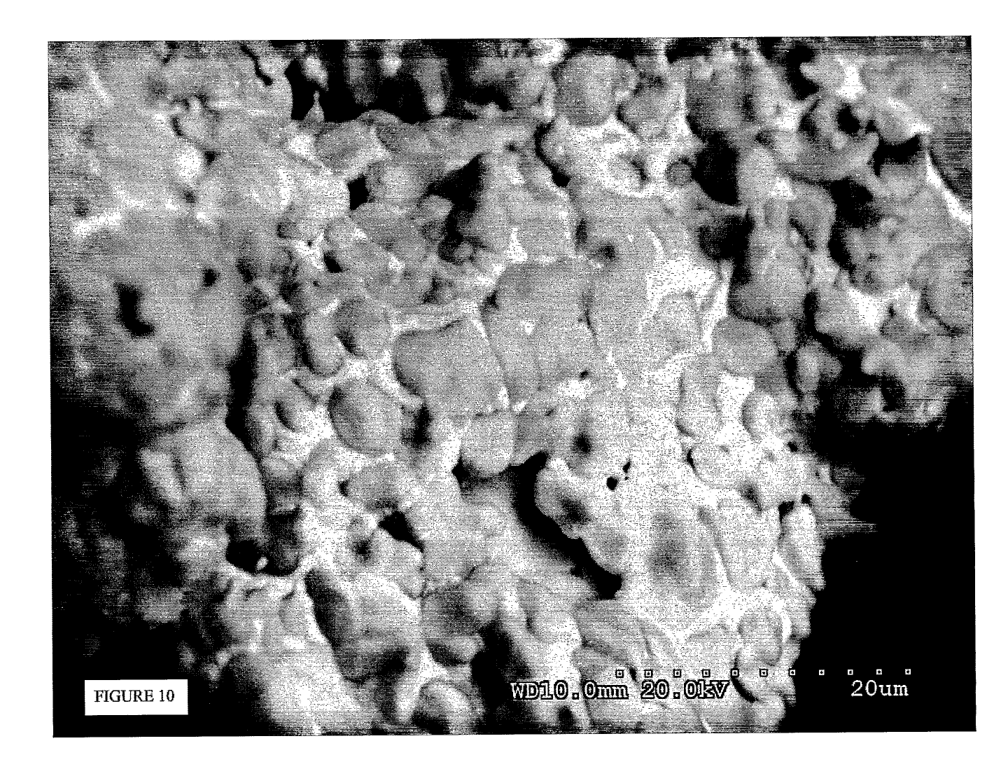

FIGS. 7 and 8 show scanning electron microscope pictures of the open cell porous Fe samples produced in accordance with the procedure described in U.S. Pat. No. 6,660,224 and detailed in Table 4. On the other hand, FIGS. 9 and 10 show back scattered scanning electron microscope pictures of the open cell porous Fe based samples produced in accordance with the present invention and detailed in Table 3. In FIGS. 9 and 10, the molten inorganic brazing alloy (mainly silver) is the one represented by the lighter shade of gray and the inorganic base material, namely the iron, is represented by the darker shade of gray. It can be clearly seen that the molten inorganic brazing alloy generally concentrate itself in the bonding area or region between two adjacent particles of the inorganic base material and in the voids on the surface of the inorganic base material particles, creating a strong, sealed joint between the inorganic particles. The remaining surface remains substantially free of the inorganic brazing alloy. In comparison, it can be clearly seen that microstructure presented in FIGS. 7 and 8 are clearly different, as no sealed joints created by an inorganic brazing alloy are present between the iron particles and that the voids on the surface of the inorganic base material particles are empty.

No formal compression tests were done to demonstrate the enhanced mechanical properties of the Fe based foam produced according to the present invention. It was evident that the Fe material produced in accordance with the procedure described in U.S. Pat. No. 6,660,224 and detailed in Table 4 had no mechanical resistance: the samples easily crumbled and were heavily damaged because of simple hand manipulation. As for the mechanical properties of the Fe based foam produced according to the present invention and detailed in Table 3, they where mechanically sound and could not be damaged by simple hand manipulation, even though they followed the exact same thermal treatment as the Fe foam samples produced in accordance with the procedure described in U.S. Pat. No. 6,660,224 and detailed in Table 4. This demonstrates that by using the brazing method of the present invention for making open cell porous material, it is possible to produce open cell porous material having better mechanical properties than open cell porous material produced by prior art processes using a sintering step, and this, while using the exact same thermal treatment during the final heating step.

### Example 3

Open cell porous metal samples, with nickel (Ni) as the based material, were produced with the formulation presented in Table 5 and in accordance with the present invention. The different constituents were dry-mixed together until the mixture became homogeneous. After mixing, the mixture was poured into a mould and foamed at 110° C. in air for 2 hours. After foaming, the material was submitted to the decomposition of the binder in a tube furnace at 400° C. for 4 hours in a dry air stream. Finally, the specimens were brazed in an Ar-25% H₂ atmosphere for 1 hour at 780° C.

TABLE 5
Formulation used for the production of the Ni based foam

| Inorganic brazing | Inorganic | Binding | Foaming |
|---|---|---|---|
| alloy particles | particles | agent | agent |
| Silver based alloy | Ni powder | Phenolic | P-toluene sulfonyl |
| (72 wt. % Ag & 28 | | resin | hydrazide |
| wt. % Cu) | | | |
| 11.7 wt. % | 58.3 wt. % | 29.5 wt. % | 0.5 wt. % |

Open cell porous nickel (Ni) samples were produced with the formulation presented in Table 6 and in accordance with the procedure described in U.S. Pat. No. 6,660,224. The different constituents were dry-mixed together until the mixture became homogeneous. After mixing, the mixture was poured into a mould and foamed at 110° C. in air for 2 hours. After foaming, the material was submitted to the decomposition of the binder in a tube furnace at 400° C. for 4 hours in a dry air stream. Finally, the specimens were sintered in an Ar-25% H₂ atmosphere for 1 hour at 780° C.

TABLE 6
Formulation used for the production of the Ni foam

| Inorganic | Binding | Foaming |
|---|---|---|
| particles | agent | agent |
| Ni powder | Phenolic | P-toluene sulfonyl |
| | resin | hydrazide |
| 70 wt. % | 29.5 wt. % | 0.5 wt. % |

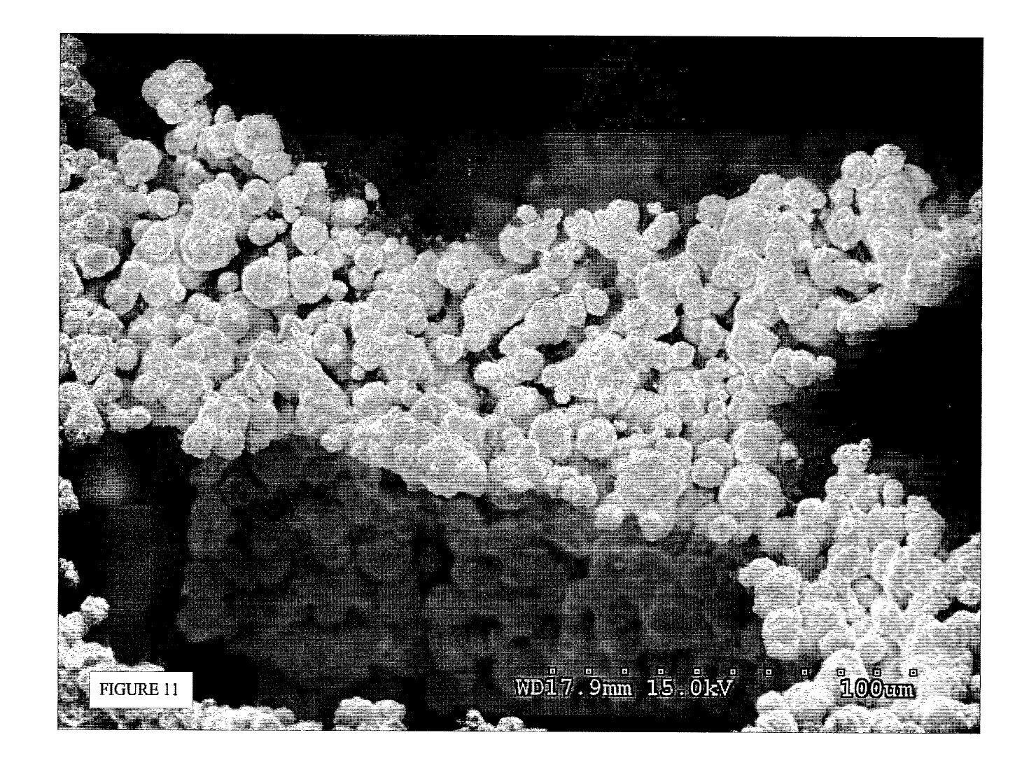

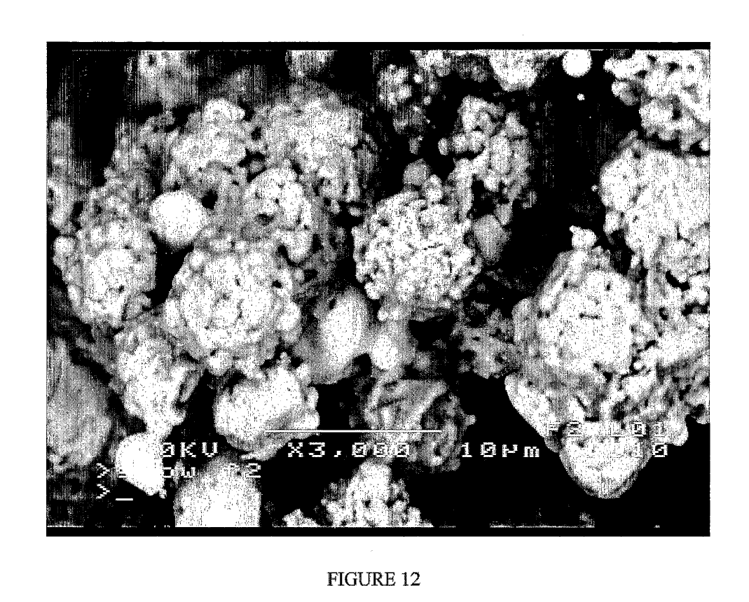

FIG. 11 shows a scanning electron microscope picture of the open cell porous Ni sample produced in accordance with the procedure described in U.S. Pat. No. 6,660,224 and detailed in Table 6. On the other hand, FIG. 12 shows a back scattered scanning electron microscope picture of the open cell porous Ni based samples produced in accordance with the present invention and detailed in Table 5. In FIG. 12, the molten inorganic brazing alloy (mainly silver) is the one represented by the lighter shade of gray and the inorganic base material, namely the nickel, is represented by the darker shade of gray. It can be clearly seen that the molten inorganic brazing alloy generally concentrate itself in the bonding area or region between two adjacent particles of the inorganic base material and in the voids on the surface of the inorganic base material particles, creating a strong, sealed joint between the inorganic particles. The remaining surface remains substantially free of the inorganic brazing alloy. In comparison, it can be clearly seen that microstructure presented in FIG. 11 is clearly different, as no sealed joints created by an inorganic brazing alloy are present between the nickel particles.

No formal compression tests were done to demonstrate the enhanced mechanical properties of the Ni based foam produced according to the present invention. It was evident that the Ni material produced in accordance with the procedure described in U.S. Pat. No. 6,660,224 and detailed in Table 6 had no mechanical resistance: the samples easily crumbled and were heavily damaged because of simple hand manipulation. As for the mechanical properties of the Ni based foams produced according to the present invention and detailed in Table 5, they where mechanically sound and could not be damaged by simple hand manipulation, even though they followed the exact same thermal treatment as the Ni foam samples produced in accordance with the procedure described in U.S. Pat. No. 6,660,224 and detailed in Table 6. This demonstrates that by using the brazing method of the present invention for making open cell porous material, it is possible to produce open cell porous material having better mechanical properties than open cell porous material produced by prior art processes using a sintering step, and this, while using the exact same thermal treatment during the final heating step.

While illustrative and specific embodiments of the invention have been described in detail hereinabove, it is to be understood that the inventive concepts may be otherwise variously embodied and employed and that the appended claims are intended to be construed to include such variations except insofar as limited by the prior art.

1.-134. (canceled)

135. A method for making an open cell porous body comprising:
a. providing a mixture including:
i. a first predetermined amount of inorganic brazing particles having a first melting temperature;
ii. a second predetermined amount of inorganic particles having a second melting temperature, the second melting temperature being higher than the first melting temperature, the inorganic particles being adapted to be brazed by the brazing particles; and
iii. a third predetermined amount of a binding agent having a decomposition temperature, the decomposition temperature being lower than the first melting temperature;
b. heating the mixture to at least the decomposition temperature to decompose the binding agent and obtain an unbrazed open cell porous body; and
c. heating the unbrazed open cell porous body in a reducing atmosphere to at least the first melting temperature to melt the inorganic brazing particles and cause the melted inorganic brazing particles to create metallic bonds between the inorganic particles.

136. A method for making an open cell porous body as recited in claim 135, wherein the inorganic brazing particles consist essentially of metal or metal alloy particles.

137. A method for making an open cell porous body as recited in claim 135, wherein the inorganic brazing particles consist essentially of silver-based brazing alloy particles.

138. A method for making an open cell porous body as recited in claim 137, wherein the silver-based brazing alloy particles include copper.

139. A method for making an open cell porous body as recited in claim 138, wherein the silver content of the silver-based brazing alloy particles is between about 56% by weight to about 100% by weight and a remainder is copper.

140. A method for making an open cell porous body as recited in claim 135, wherein the first predetermined amount is between about 1 wt % to about 60 wt % inclusive of a total weight of the mixture.

141. A method for making an open cell porous body as recited in claim 140, wherein the first predetermined amount is between about 5 wt % to about 45 wt % inclusive of the total weight of the mixture.

142. A method for making an open cell porous body as recited in claim 135, wherein heating the unbrazed open cell porous body in a reducing atmosphere to at least the first melting temperature to melt the inorganic brazing particles and cause the melted inorganic brazing particles to create metallic bonds between the inorganic particles is carried out in an absence of flux.

143. A method for making an open cell porous body as recited in claim 135, wherein the mixture further includes a fourth predetermined amount of a foaming agent; the method further comprising heating the mixture to induce foaming thereof before heating the mixture at the decomposition temperature to decompose the binding agent and obtain an unbrazed open cell porous body.

144. A method for making an open cell porous body as recited in claim 143, wherein the inorganic brazing particles consist essentially of metal or metal alloy particles.

145. A method for making an open cell porous body as recited in claim 143, wherein the inorganic brazing particles consist essentially of silver-based brazing alloy particles.

146. A method for making an open cell porous body as recited in claim 145, wherein the silver-based brazing alloy particles include copper.

147. A method for making an open cell porous body as recited in claim 146, wherein the silver content of the silver-based brazing alloy particles is between about 56% by weight to about 100% by weight and a remainder is copper.

148. A method for making an open cell porous body as recited in claim 143, wherein the first predetermined amount is between about 1 wt % to about 60 wt % inclusive of a total weight of the mixture.

149. A method for making an open cell porous body as recited in claim 148, wherein the first predetermined amount is between about 5 wt % to about 45 wt % inclusive of the total weight of the mixture.

150. A method for making an open cell porous body as recited in claim 143, wherein heating the unbrazed open cell porous body in a reducing atmosphere to at least the first melting temperature to melt the inorganic brazing particles and cause the melted inorganic brazing particles to create metallic bonds between the inorganic particles is carried out in an absence of flux.

151. An open cell porous body made according to the method recited in claim 143.

152. An open cell porous body made according to the method recited in claim 135.

153. A mixture for making open cell porous bodies, the mixture comprising:
a. a first predetermined amount of inorganic brazing particles having a first melting temperature;
b. a second predetermined amount of inorganic particles having a second melting temperature, the second melting temperature being higher than the first melting temperature, the inorganic particles being adapted to be brazed by the brazing particles; and
c. a third predetermined amount of a binding agent having a decomposition temperature, the decomposition temperature being lower than the first melting temperature;

154. A mixture as recited in claim 153, further comprising a fourth predetermined amount of a foaming agent.
